(19) United States
(12) Patent Application Publication
(10) Pub. No.: US 2008/0133654 A1
(43) Pub. Date: Jun. 5, 2008

(54) NETWORK BLOCK DEVICE USING NETWORK ASYNCHRONOUS I/O

(76) Inventors: Chei-Yol KIM, Daejon (KR); Eun-Ji LIM, Daejon (KR); Kang-Ho KIM, Daejon (KR); Baik-Song AN, Daejon (KR); Sung-In JUNG, Daejon (KR); Myung-Joon KIM, Daejon (KR)

Correspondence Address: LADAS & PARRY LLP, 224 SOUTH MICHIGAN AVENUE, SUITE 1600, CHICAGO, IL, 60604, US

(21) Appl. No.: 11/948,329

(22) Filed: Nov. 30, 2007

(30) Foreign Application Priority Data
Dec. 1, 2006 (KR) 10-2006-0120490

(51) Int. Cl. G06F 15/16

(52) U.S. Cl. 709/203

(57) ABSTRACT

A network block device using a network asynchronous I/O method is provided. The network block device includes an asynchronous I/O interface for managing a plurality of socket connections; an request process unit for analyzing a request from a client through a socket, reading data from a disk and transmitting the read data to the client through the socket, and writing the data transmitted through the socket to the disk, through the asynchronous I/O interface; and a request processing unit for collecting a result event of processing an operation asynchronously requested by the request processing unit and informing the request processing unit of the collected result event, through the asynchronous I/O interface.

### CROSS-REFERENCE(S) TO RELATED APPLICATIONS

The present invention claims priority of Korean Patent Application No. 10-2006-0120490, filed on Dec. 1, 2006, which is incorporated herein by reference.

### BACKGROUND OF THE INVENTION

1. Field of the Invention

The present invention relates to a network block device using a network asynchronous input/output (I/O) method; and, more particularly, to a network block device using a network asynchronous I/O method for providing a network block device (NBD) to a client using a network asynchronous I/O (NAIO) method and an effective data transmission method.

This work was supported by the IT R&D program for MIC/IITA [2005-S-119, “The Development of Open SW Fundamental Technology”]

2. Description of Related Art

A network block device (NBD) denotes an apparatus and a service that enable a disk device or a block device such as partitions and files in a remote location to be recognized as a block device in a host system. The network block device includes a server for providing block data and a client using a block device by receiving the service thereof. The server and the client transfer block data between a disk and a network.

A NBD server according to the related art processes a NBD service by generating a new process whenever a NBD client requests socket connection for the NBD service. Also, the NBD server according to the related art uses a user buffer when data copies from a disk to another disk through a network.

FIG. 1 is a diagram illustrating a service model of a conventional network block device (NBD) server. That is, FIG. 1 shows a procedure for allocating processes to each socket to process a plurality of socket connections in a network block device (NBD) according to the related art.

As shown in FIG. 1, the NBD server according to the related art processes a service by allocating a process to each socket that processes a request from each client in order to process a plurality of clients. The NBD server according to the related art has no difficulty to process services for the comparatively small number of clients. If the number of clients becomes increased, the NBD server according to the related art frequently generates context switch for processing requests of clients. That is, the NBD server uses the large amount of computing resources to perform frequent context switch rather than processing a real service. Therefore, the service performance thereof becomes deteriorated due to the context switch overload.

In order to overcome such a problem, a network asynchronous input/output (I/O) method for a network block device (NBD) server was introduced. In the network asynchronous I/O method, if a data I/O process cannot be completed at once, a user process is blocked until the data I/O process is completed. Therefore, the efficiency thereof decreases. Also, the NBD server needs N processes to process the N number of NBD clients, where N denote a natural number. Furthermore, the NBD server needs N socket connections for processing each service. Each of the sockets is designed to process only corresponding request using the synchronous I/O method. Therefore, there is a demand for overcoming such shortcomings of the network asynchronous I/O method according to the related art.

### SUMMARY OF THE INVENTION

An embodiment of the present invention is directed to providing a network block device (NBD) using a network asynchronous input/output (I/O) method for effectively providing a service to a plurality of NBD clients with the small number of processes or threads using a network asynchronous I/O method and a direct data transmission method without using a user buffer when data is transferred between a disk and a network.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a network block device using a network asynchronous input/output (I/O) method, including: an asynchronous input/output (I/O) interface for managing a plurality of socket connections; an request processing unit for analyzing a request from a client through a socket, reading data from a disk and transmitting the read data to the client through the socket, and writing the data transmitted through the socket to the disk, through the asynchronous I/O interface; and a request processing unit for collecting a result event of processing an operation asynchronously requested by the request processing unit and informing the request processing unit of the collected result event, through the asynchronous I/O interface.

### BRIEF DESCRIPTION OF THE DRAWINGS

FIG. 1 is a diagram illustrating a service model of a conventional network block device (NBD) server.

FIG. 2 is a block diagram illustrating a network block device (NBD) server using network asynchronous input/output (I/O) method in accordance with an embodiment of the present invention.

FIG. 3 is a detailed diagram illustrating a NBD server in accordance with an embodiment of the present invention.

FIG. 4 is a flowchart describing a request process thread among two threads in a network block device using network asynchronous input/output method in accordance with an embodiment of the present invention.

FIG. 5 is a flowchart describing major operations performed when an accept command is completed as an event in FIG. 4.

FIG. 6 is a flowchart describing major operations performed when a read command is completed as an event in FIG. 4.

FIG. 7 is a flowchart describing major operations performed when a write command is completed as an event in FIG. 4.

FIG. 8 is a flowchart describing major operations performed when a sendfile command is completed as an event in FIG. 4.

FIG. 9 is a flowchart describing an event collection process thread among two threads in a network block device using network asynchronous input/output method in accordance with an embodiment of the present invention.

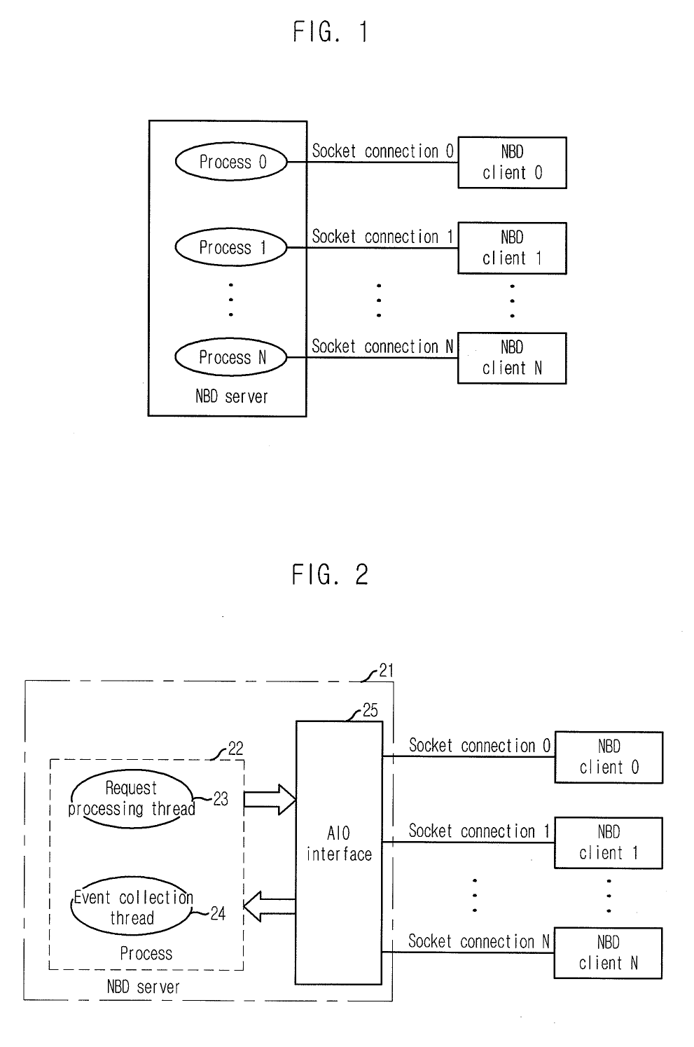

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

FIG. 2 is a block diagram illustrating a network block device (NBD server) using network asynchronous input/output (I/O) method in accordance with an embodiment of the present invention.

Referring to FIG. 2, the NBD server 21 according to the present embodiment includes a process 22, a request process thread 23, an event collection thread 24, and an asynchronous I/O (AIO) interface 25.

In more detail, the NBD server 21 includes the AIO interface 25 for managing a plurality of socket connections, the request process thread 23 for analyzing a request of a client received through a socket through the AIO interface 25, reading data from a disk and transmitting the read data to the client through the socket, and writing the data transmitted through the socket on the disk, and the event collection thread 24 for collecting result events of processing operations asynchronously requested by the request process thread 23 and informing the request process thread 23 of the result event.

Hereinafter, the operations of the NBD server using network asynchronous I/O method according to an embodiment of the present invention will be described.

The NBD server 21 according to the present embodiment transfers block data to a client or receives block data from a client and stores the block data in a disk. In general, a buffer memory in a user area is allocated to transfer data between a disk and a network. In this case, Linux or Unix type operating system provides a system call “sendfile” to prevent unnecessary memory copy. However, the sendfile command was only allowed to use when data in a disk is transferred to a network. In the present embodiment, the sendfile command is allowed to use for transferring data from a disk to a network and from the network to the disk.

That is, the NBD server 21 can process a plurality of sockets the minimum two treads 23 and 24 in one process 22 using the AIO interface 25 without using a plurality of process. Since the asynchronous I/O method does not “sleep” for one socket request, a plurality of socket requests can be processed at the same time. The request process thread 23 analyzes a request from a socket, reads data from a disk, and transmits the read data. The request process thread 23 also writes data from a socket to a disk. The event collection thread 24 receives a result event of processing asynchronous request process and informs the request process thread 23 of the result event. As described above, the NBD server can provides a NBD service using minimum two threads. According to a given computing environment, it is advantageous to increase the number of each thread.

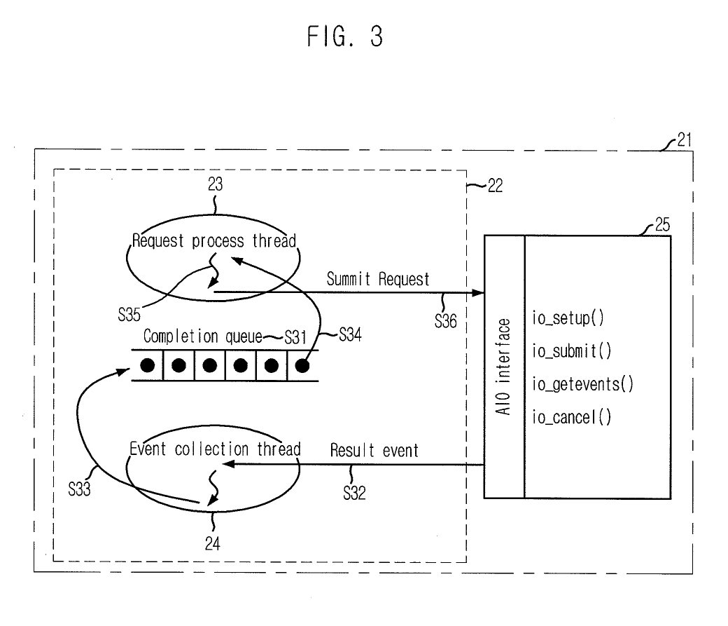

The operations of the NBD server using a network asynchronous I/O method according to the present embodiment will be described in more detail with reference to FIGS. 3 to 9.

FIG. 3 is a detailed diagram illustrating a NBD server in accordance with an embodiment of the present invention. That is, FIG. 3 shows a configuration for transferring an event through a completion queue between two threads and a detailed configuration of the AIO interface 25.

As shown in FIG. 3, a completion queue 31 is disposed between a request process thread 23 and an event collection thread 24. The event collection thread 24 receives a result event of processing a request through the asynchronous I/O interface 25 at step S32 and stores the received result event in the completion queue 31 at step S33. The request process thread 23 reads events from the completion queue 31 at step S33. Also, the request process thread 23 reads events from the completion queue 31 and perform an operation according to the read event at step S35. A submit request related to all sockets is called using the AIO interface 25 at step S36. Herein, the request process thread 23 confirms an event denoting whether the request is completed or not from a local machine.

In the present embodiment, an AIO interface 25 included in a Linux Kernel version 2.6 is used. The AIO interface 25 includes io_setup( ) as an initialization process for asynchronous I/O, io_sumbit( ) used when a request is transmitted, io_getevents( ) for determining whether a request process is completed or not and receiving an error value, and io_cancel( ) for releasing related resources after completing an asynchronously I/O process.

In the present embodiment, below network asynchronous I/O functions are provided.

ACCEPT

SEND (WRITE)

RECEIVE (READ)

SENDFILE (disk→network, network→disk)

The functions ACCEPT, SEND, and RECEIVE are widely known. However, the function SENDFILE is used to immediately send the data of a file to a socket or instantly store data in a disk.

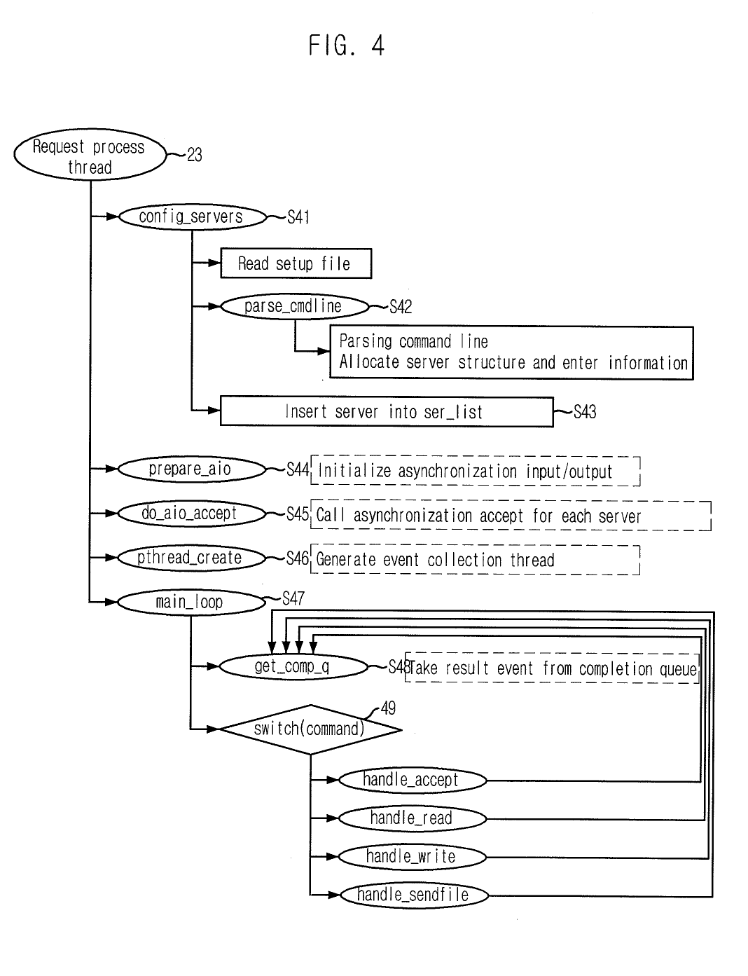

FIG. 4 is a flowchart describing a request process thread among two threads in a network block device using network asynchronous input/output method in accordance with an embodiment of the present invention.

As shown in FIG. 4, the request process thread 23 performs an initialization process by reading a setup file at step S41. In the initialization process, the request process thread reads a setup file, creates a structure named “SERVER” per each block devices to provide a service according to the setup file, and stores the created structure “SERVER” in each block device at step S42. The created SERVER structures are linked through a server list ser_list at step S43. The server list ser_list is used by the NBD server to refer information about a block device that a service is provided to. Also, the server list ser_list is used to release the service. After initializing the information about the block device, an asynchronous I/O initialization process is performed to use an network asynchronous I/O method at step S44.

After initialization, an accept call is requested using asynchronous I/O to enable clients to connect a block device to service at step S45. Unlike the synchronous I/O, the request process thread can perform the next process without waiting a client to be connected after requesting an accept call.

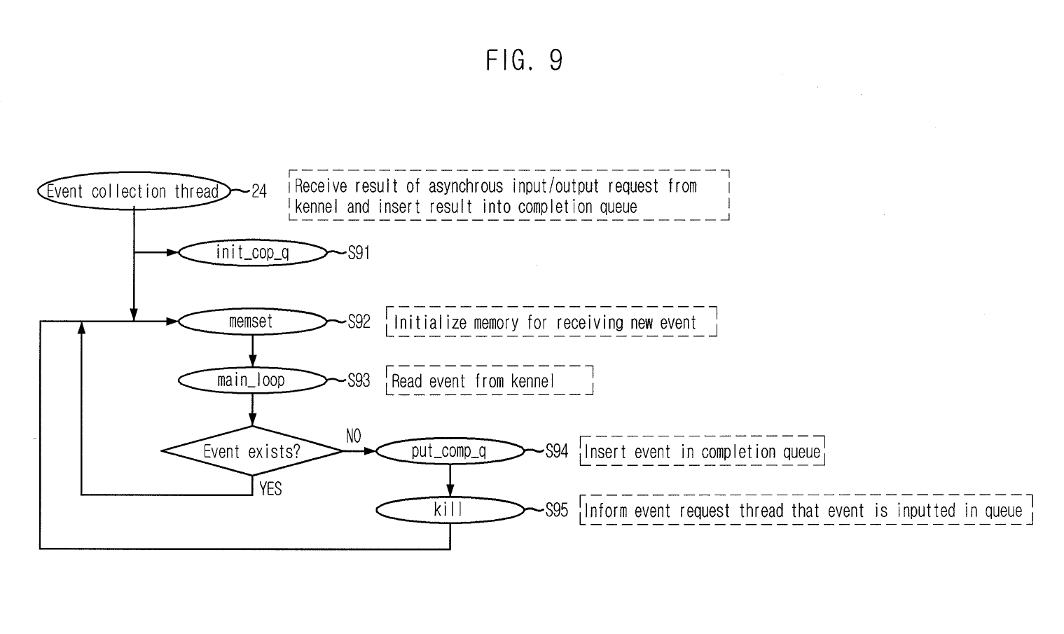

After requesting the accept call, an event collection thread is generated at step S46. The event collection thread receives a result event 32 of processing the request from the request process thread 23 and stores the received result event in the completion queue 31, which will be described in detail with reference to FIG. 9 in later.

The request of a client can be processed through a main_loop 47 which is repeatedly performed after the above steps are performed. The main_loop 47 can be divided in two processes. One process is that the event collection thread 24 reads a result event in the completion queue 31 at step S48. The other process is a switch routine 49 that process corresponding operation according to each event by analyzing the read event. The switch routine 49 calls different functions according to the types of requests requested through event information, such as accept, send, receive, and sendfile, and processes corresponding operations. The result event 32 denoting the result of asynchronous I/O request includes a result value and an address value of the request. The request process thread 23 determines what the request is according to the request address and performs different functions according to the determination result.

Hereinafter, the operations of each function will be described.

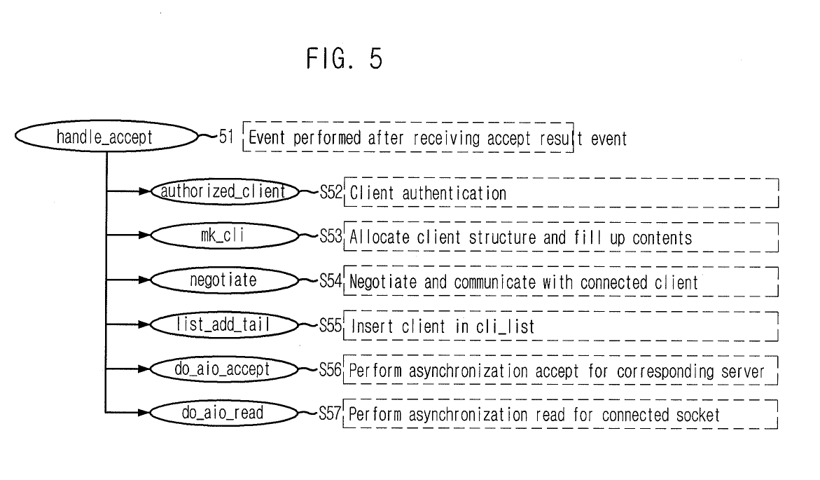

FIG. 5 is a flowchart describing major operations performed when an accept command is completed as an event in FIG. 4. That is, FIG. 5 shows the operation of a function handle_accept 51 performed when a result event is an event for an “accept” command in the switch routine 49.

As shown in FIG. 5, the result event of an accept call is obtained as a result of an accept request performed in the step S45 of FIG. 4. That is, it means that a NBD client requests to be connected. After connecting to the client, a request client is authenticated at step S52 to determine whether the request is accepted or refused. Then, if the request is accepted, a structure “CLIENT” is created for reserving information for a client at step S53. Then, it is determined whether the server communicates with the client without problems by negotiation between a server and a client according to a NBD protocol at step S54. Then, the client structure is connected to the client list cli_list at step S55.

In order to receive a next connection request, an accept request is transmitted again using a function do_aio_accept( ) at step S56, and a function do_aio_read( ) is performed at step S57 for receiving a NBD command from a client. The function do_aio_read( ) is an asynchronous input/output request and performs the same operation of calling a function read( ) through a socket.

The above described operations are performed when the request process thread 23 receives a connection request from a client. After the client is connected, a result of a read request, which is transmitted through the function do_aio_read( ) according to the NBD protocol, is received, and a NBD service is performed to a client.

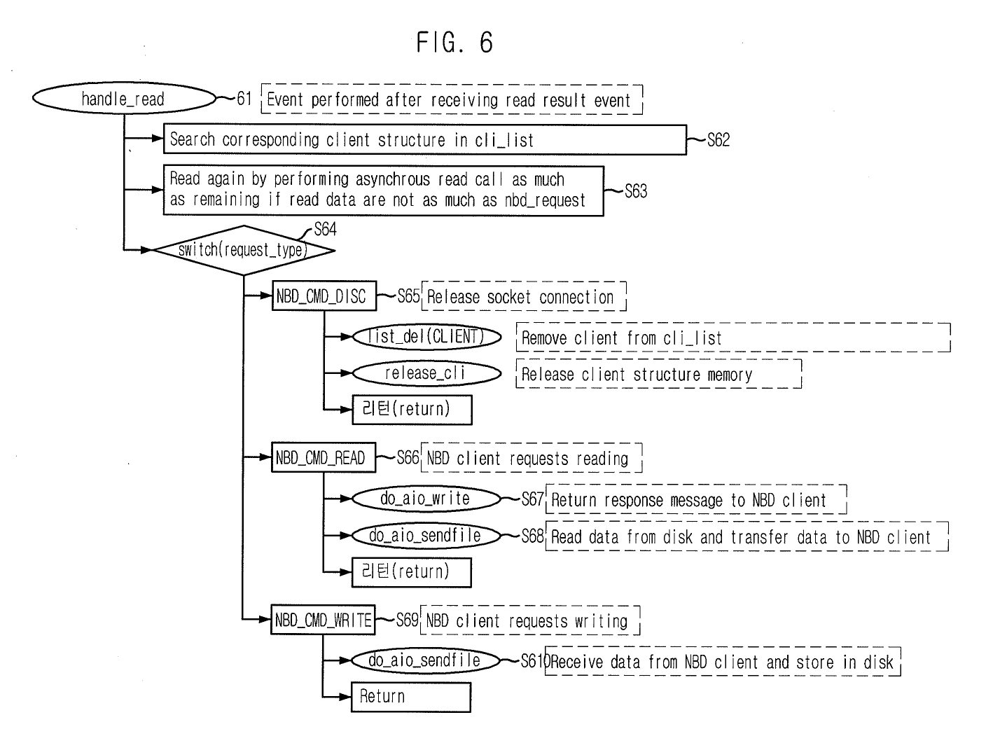

Hereinafter, the operation of a function handle_read( ) which is performed after the request process thread 23 receives a read request will be described with reference to FIG. 6.

FIG. 6 is a flowchart describing major operations performed when a read command is completed as an event in FIG. 4. That is, FIG. 6 shows a procedure that the function handle_read( ) 61 receives a block device service request from a NBD client and processes the block device service request.

As shown in FIG. 6, the function handle_read( ) searches a corresponding client structure with reference to the information about a socket through the client list cli_list at step S62. Then, if the size of the read data is smaller than the size of a structure nbd_request having the NBD request, a read request is sent for requesting reading incompletely as much as the remaining size. If not, data is received as much as the nbd_request structure at step S63. The received data is analyzed and different operations are performed according to three commands at step S64. The three commands are a command NBD_CMD_DISC 65, a command NBD_CMD_READ 66, and a command NBD_CMD_WRITE 69.

The command NBD_CMD_DISC 65 is a command for releasing connection. In case of receiving the connection release command, a corresponding client structure is removed from the client list, and a memory of the client structure is collected and returned.

The command NBD_CMD_READ 66 is a request for a client to read block data from a server. In this case, a NBD server according to the related art reads data to a buffer of a user area and transmits the data to a client using a command write( ) for a socket. On the contrary, the NBD server according to the present embodiment directly transmit data to a socket from a disk without copying data in a user area through the sendfile call of the asynchronous I/O method at step S68.

Since the MBD protocol attaches response data in front of block data and transmits the response data with the block in case of the command NBD_CMD_READ, a function do_aio_write( ) is performed for transmitting the response data at step S67 before the block data is transmitted through a sendfile command. Then, a client confirms whether received data is the request data using the respond data attached in front of the block data and uses the block data thereof.

The command NBD_CMD_WRITE 69 is a request for a client to write data. In this case, a client transmits block data to stored in a server by attaching the block data at the back of the command. In the present embodiment, a sendfile command for directly writing block data at a server is called in the asynchronous I/O method at step S610.

The sendfile command includes two file descriptors as a factor. One of the file descriptors denotes a source, and the other denotes a destination. That is, if a source is a file descriptor and a destination is a socket descriptor, the sendfile command reads corresponding data from a disk and transmits the read data to a socket. That is, the sendfile command can transmit data from a disk to a network and from the network to the disk through the same interface sendfile. Therefore, the commands NBD_CMD_READ 66 and NBD_CMD_WRITE 69 can transmit data to a socket or receive data from a socket using the interface sendfile in the present embodiment.

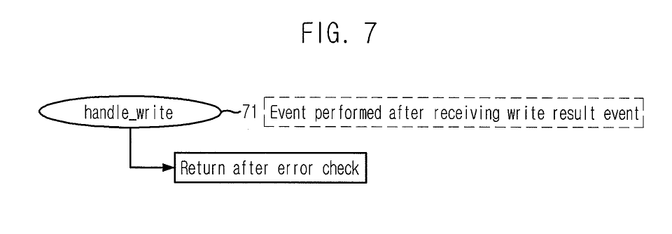

FIG. 7 is a flowchart describing major operations performed when a write command is completed as an event in FIG. 4. That is, FIG. 7 shows a procedure when the result event is a result value for write as a function handle_write( ) 71.

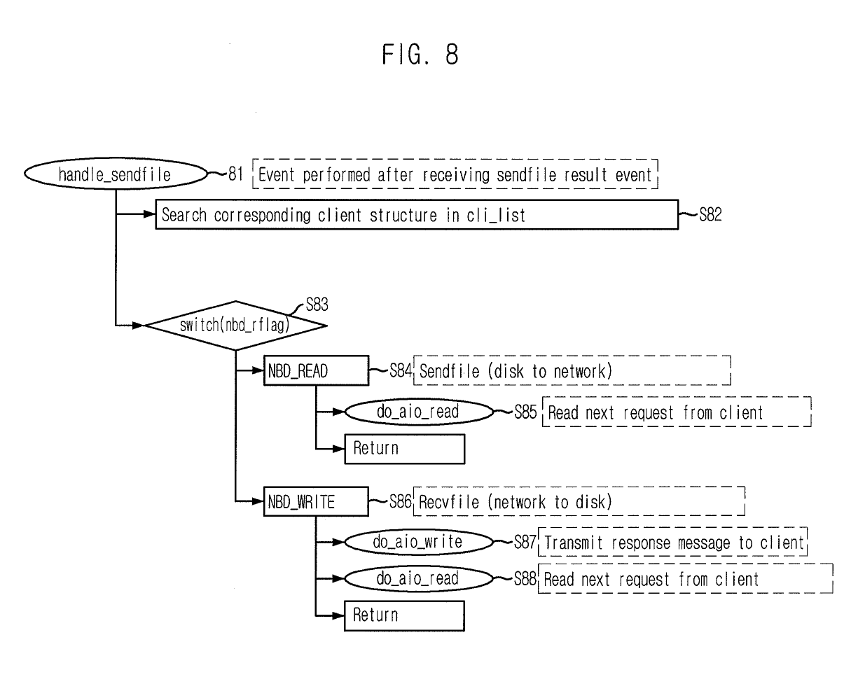

As shown in FIG. 7, a write process is performed when a command NBD_CMD_READ 66 is received and the response data thereof is transmitted and when response data is transmitted in FIG. 8. Therefore, the write process is terminated without post processes if no error occurs.

FIG. 8 is a flowchart describing major operations performed when a sendfile command is completed as an event in FIG. 4. That is, FIG. 8 shows a function hand_sendfile( ) 81 when the sendfile request is completed.

As shown in FIG. 8, the sendfile request is called from the function handle_read( ) 61 in FIG. 6. As shown in FIG. 6, the sendfile request is called by a read request and a write request of a client. The operations thereof are different, which were described already.

The function handle_sendfile( ) 81 searches a client structure of a corresponding socket from a client list at step S82, and determines whether the processing sendfile is for the read request of a client or for the write request of a client by checking a flag nbd_rflag at step S83.

If the processing sendfile is for the read request at step S84, the processing sendfile command is a sendfile command for transmitting data from a server disk to a client (disk→network) as described above. Since the response data is transmitted at first at step S67, it is only required to check an error. Then, a read request is preformed at step S85 using the asynchronous I/O method in order to receive a next request from a client.

If the processing sendfile command is a sendfile command for the write request at step S86, it is a sendfile command for storing data received from a client in a server disk (network→disk). After data is completely received from a client, acknowledgement data is transmitted to the client through a function do_aio_write( ) at step S87. Then, a read request is performed using the asynchronous I/O method to receive a next request from the client at step S88.

As described above, the request process thread can effectively process a plurality of socket connections with one thread by using the asynchronous I/O method.

Hereinafter, the structure and the operations of the event collection thread will be described with reference to FIG. 9.

FIG. 9 is a flowchart describing an event collection process thread among two threads in a network block device using network asynchronous input/output in accordance with an embodiment of the present invention. That is, FIG. 9 shows a procedure of receiving results of asynchronous request from a request process tread and stores the received results to enable the request process thread to use the results.

As shown in FIG. 9, the event collection thread 24 initializes a completion queue at step S91 and initializes a memory for storing events at step S92. If a result event is received after waiting for while, the event collection thread 24 reads the result event at step S93. Herein, the event collection thread 24 does not wait the result event infinitely. If the result event is received, the event is stored in a completion queue at step S94 and the event collection thread 24 awakes the event request thread at step S95. The event collection thread 24 read the result event of the network asynchronous I/O requests and transfers the result events to the request process thread by performing the above described steps.

As described above, the NBD server 21 instantly returns a process if a related I/O operation cannot be completed and performs a next operation. If the I/O operation is completed, the NBD server 21 generates an event to inform a process in order to enable the process requesting the operation to recognize the request I/O operation is completed.

The efficiency server operation can be improved using the asynchronous I/O method according to the present embodiment in a view of a server that performs the large amount of I/O processes. Also, a server program instantly performs a next operation without blocking in the I/O operation using the asynchronous I/O function. Therefore, the throughput can be improved a lot. In case of an Internet server that manages a plurality of network connections, the number of users to use the Internet server at the same time can increase.

As described above, the NBD service can be effectively provided to a plurality of clients using asynchronous characteristics without using a plurality of processes or threads.

That is, the same operation can be performed with a low CPU use rate by reducing context overhead generated when a plurality of processes are used. Therefore, effective service can be provided.

The memory copy is reduced using the sendfile command that does not use a buffer in a user space to provide block data having a disk to a network. Therefore, the performance of a server can be improved.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

While the present invention has been described with respect to certain preferred embodiments, it will be apparent to those skilled in the art that various changes and modifications may be made without departing from the spirits and scope of the invention as defined in the following claims.

What is claimed is:

1. A network block device using a network asynchronous input/output (I/O) method, comprising:
an asynchronous input/output (I/O) interfacing means for managing a plurality of socket connections;
a request processing means for analyzing a request from a client through a socket, reading data from a disk and transmitting the read data to the client through the socket, and writing the data transmitted through the socket to the disk, through the asynchronous I/O interfacing means; and
a request processing means for collecting a result event of processing an operation asynchronously requested by the request processing means and informing the request processing means of the collected result event, through the asynchronous I/O interfacing means.

2. The network block device of claim 1, wherein the event collecting means stores the result event in a completion queue and informing the request processing means of the arrival of the result event.

3. The network block device of claim 2, wherein the request processing means reads the result event stored in the completion queue by the event collecting means while turning a loop using a network asynchronous I/O function, analyzes the result event, calling a corresponding function based on the analyzing result, and performs a corresponding operation.

4. The network block device of claim 2, wherein the result event includes a result value of an asynchronous I/O request and an address value of a request, and the request processing means reads the result event stored in the completion queue, analyzes the request context through the request address value, calls a corresponding function based on the analyzing result, and performs a corresponding operation.

5. The network block device of claim 1, wherein the network block device processes a plurality of socket requests in one process, and performs a service by directly copying data from a disk to a network without using a buffer of a user space in order to service block data to the client in a remote location through an network.

6. The network block device of claim 5, wherein the request process means stores information about a client requesting to be connected if a result event of an accept call is received, calls an asynchronous accept call for the same block data service connection, and calls an asynchronous read call to receiving a network block command for a previously connected socket.

7. The network block device of claim 5, wherein the request processing means calls a sendfile command for transmitting data between a network to a disk by selecting an input/output direction according to a network block device command of a client in order to prevent data copy in a user area if a result event of a read call is received.

8. The network block device of claim 5, wherein the request processing means determines whether transmitted data to the client is successfully arrived or not by checking an error if a result event of a write call is received.

9. The network block device of claim 5, wherein the request processing means confirms a flag defined in a client structure when a result event of a sendfile call is received, a read call is requested for receiving a next network block device (NBD) command of the client if the flag is NBD_READ, a write call is requested for transmitting a response message to the client if the flag is NBD_WRITE.
